(19) United States
(12) Patent Application Publication
(10) Pub. No.: US 2014/0092860 A1
(43) Pub. Date: Apr. 3, 2014

(54) CHANNEL RESERVATION IN WIRELESS NETWORK

(71) Applicant: Nokia Corporation, ESPOO (FI)

(72) Inventors: Jarkko Kneckt, Espoo (FI); Eng Hwee Ong, Singapore (SG); Janne Marin, Espoo (FI); Mika Kasslin, Espoo (FI)

(21) Appl. No.: 14/123,901

(22) PCT Filed: Jun. 16, 2011
(86) PCT No.: PCT/FI2011/050576

§ 371 Date: Dec. 4, 2013

(51) Int. Cl. H04W 72/12

(52) U.S. Cl. CPC H04W 72/1205
USPC 370/329

(57) ABSTRACT

Methods, apparatuses, and a computer program are presented for carrying out channel reservations in a wireless communication system. A communication apparatus initiates a channel reservation procedure. During the channel reservation procedure, the communication apparatus is caused to transmit a reservation request message comprising information elements specifying at least one secondary channel being reserved and a communication direction for at least one channel being reserved. Upon completed reservation procedure, the communication apparatus is caused to utilize the reserved at least one secondary channel in wireless communication in the communication direction specified in the reservation request message.

### FIELD

The invention relates to the field of wireless telecommunications and, particularly, to carrying out channel reservation for a data transmission in a wireless communication system.

### BACKGROUND

Some wireless communication systems negotiate radio channel reservation prior to carrying out actual data transmissions on the radio channel. The channel reservation is carried out in order to reduce the probability of colliding transmissions. Improved channel reservation mechanisms are needed to improve the performance of such wireless communication systems.

### BRIEF DESCRIPTION

According to an aspect of the present invention, there are provided methods as specified in claims 1 and 16.

According to another aspect of the present invention, there are provided apparatuses as specified in claims 18 and 32.

According to another aspect of the present invention, there is provided an apparatus as specified in claim 35.

According to yet another aspect of the present invention, there is provided a computer program product embodied on a computer readable distribution medium as specified in claim 36. According to yet another aspect, there is provided a computer-readable distribution medium comprising the computer program product.

Embodiments of the invention are defined in the dependent claims.

### LIST OF DRAWINGS

Embodiments of the present invention are described below, by way of example only, with reference to the accompanying drawings, in which

FIGS. 1A and 1B illustrate an example of a wireless communication system to which embodiments of the invention may be applied;

FIGS. 2A and 2B illustrate a flow diagram of a process according to an embodiment of the invention;

FIG. 3 illustrates a signalling diagram related to channel reservation according to an embodiment of the invention;

FIGS. 4 and 5 illustrate examples of channel reservation according to an embodiment of the invention;

FIG. 6 illustrates a flow diagram of a process for carrying out channel access on a reserved channel according to an embodiment of the invention;

FIGS. 7 to 10 illustrate how the reservations are protected and how data transmissions affect the protection according to some embodiments of the invention; and

FIG. 11 illustrates a block diagram of an apparatus according to an embodiment of the invention.

### DESCRIPTION OF EMBODIMENTS

The following embodiments are examples. Although the specification may refer to “an”, “one”, or “some” embodiment(s) in several locations, this does not necessarily mean that each such reference is referring to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

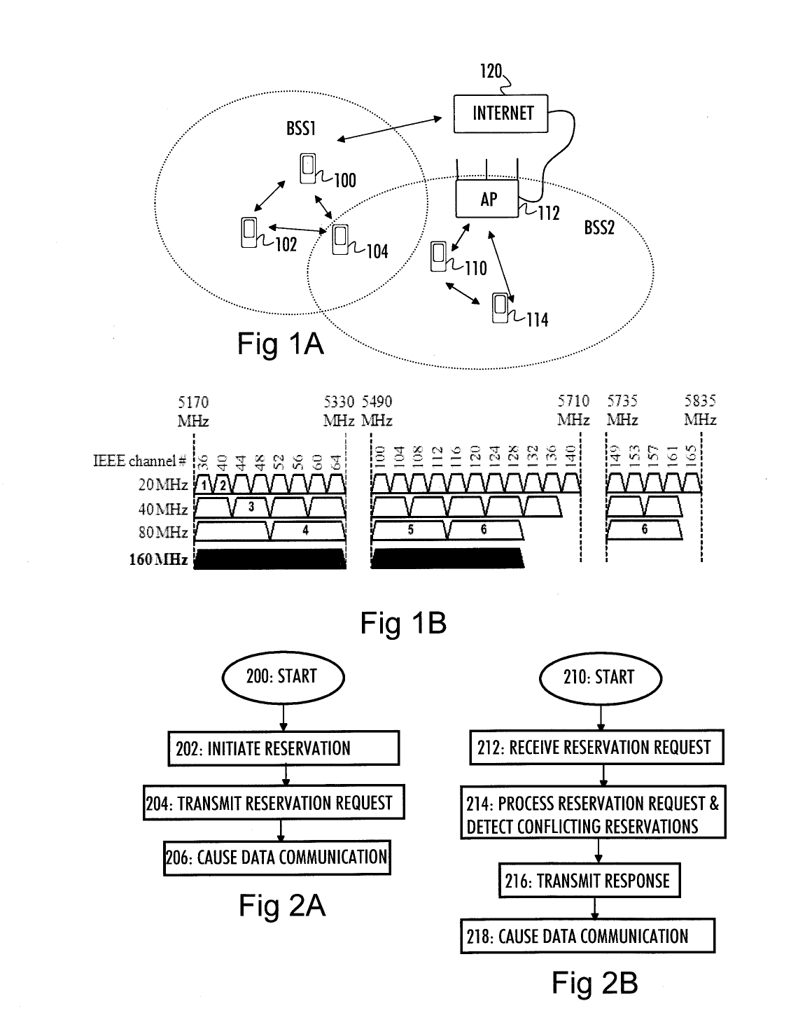

A general architecture of a wireless telecommunication system to which embodiments of the invention may be applied is illustrated in FIG. 1A. FIG. 1A illustrates two groups of wireless communication devices forming two basic service sets, e.g. groups of wireless communication devices comprising an access point (AP) 100, 112 and terminal stations (STA) 102, 104, 110, 114 communicating with the access points 100, 112 of their respective groups. A basic service set (BSS) is a basic building block of an IEEE 802.11 wireless local area network (WLAN). The most common BSS type is an infrastructure BSS that includes a single AP together with all associated STAs. The AP may be a fixed AP as AP 112, or it may be a mobile AP as AP 100. The APs 100, 112 may also provide access to other networks, e.g. the Internet 120. In another embodiment, at least one of the BSSs is an independent BSS (IBSS) or a mesh BSS (MBSS) without a dedicated AP, and in such embodiments the communication device 100 may be a non-access-point terminal station. While embodiments of the invention are described in the context of the above-described topologies of IEEE 802.11 and, particularly, IEEE 802.11ac, it should be appreciated that these or other embodiments of the invention may be applicable to networks based on other specifications, e.g. other versions of the IEEE 802.11, WiMAX (Worldwide Interoperability for Microwave Access), UMTS LTE (Long-term Evolution for Universal Mobile Telecommunication System), and other networks having cognitive radio features, e.g. transmission medium sensing features and adaptiveness to coexist with radio access networks based on different specifications and/or standards. Some embodiments may be applicable to networks having features under development by IEEE 802.19 task group.

The 802.11n specifies a data transmission mode that includes 20 MHz wide primary and secondary channels. The primary channel is used in all data transmissions, and with clients supporting only the 20 MHz mode. A further definition in 802.11n is that the primary and secondary channels are adjacent. The 802.11n specification also defines a mode in which a STA can have only one secondary channel which results in a maximum bandwidth of 40 MHz. IEEE 802.11ac task group extends such an operation model to provide for wider bandwidths by increasing the number of secondary channels from 1 up to 7, thus resulting in bandwidths of 20 MHz, 40 MHz, 80 MHz, and 160 MHz. FIG. 1B illustrates an exemplary channel structure for 20 MHz, 40 MHz, 80 MHz, and 160 MHz channels. In this example, a 40 MHz transmission band is formed by two contiguous 20 MHz bands (denoted by numerals 1 and 2 in FIG. 1B), and an 80 MHz transmission band is formed by two contiguous 40 MHz bands (numerals 1, 2, 3). However, a 160 MHz band may be formed by two contiguous (numerals 1 to 4) or non-contiguous 80 MHz bands (numerals 1 to 3 for a first 80 MHz band and any one of bands denoted by numerals 5 and 6 for a second 80 MHz band).

As mentioned above, the transmission band of a BSS contains the primary channel and zero or more secondary channels. The secondary channels may be used to increase data transfer capacity of the transmission opportunity (TXOP). The secondary channels may be called a secondary channel, a tertiary channel, a quaternary channel, etc. However, let us for the sake of simplicity use the secondary channel as the common term to refer also to the tertiary or quaternary channel, etc. The primary channel may be used for channel contention, and a TXOP may be gained after successful channel contention on the primary channel. Some IEEE 802.11 networks are based on carrier sense multiple access with collision avoidance (CSMA/CA) for channel access. Every STA is reducing a backoff value while the primary channel is sensed to be idle for a certain time interval, for instance 9 microseconds. When the backoff value reaches zero, the STA gains the TXOP and starts transmission. If another STA gains the TXOP before that, the backoff value is suspended, and the STA proceeds with the backoff after the TXOP of the other STA has ended and the primary channel is sensed to be idle. The time duration (the backoffvalue) may not be decremented at this stage, and the time duration that already lapsed before the suspension is also counted, which means that the STA now has a higher probability of gaining the TXOP. A secondary channel may be used in the transmission if it has been free for a determined time period (may be the same or different time period than that used for gaining the TXOP) just before TXOP start time in order for the contending STA to take the secondary channel in use. Some IEEE 802.11 networks utilize an enhanced version of the CSMA/CA where prioritized transmissions are taken into account. An example, of such an enhanced CSMA/CA is enhanced distributed channel access (EDCA) where the backoff value and a contention window (a time period when the channel contention is carried out) are selected to prioritize access classes having a higher priority, e.g. a higher quality-of-service classification. The EDCA is also carried out on the primary channel, and a STA winning the contention may expand the transmission band to the secondary channel(s) if the secondary channel(s) have been sensed to be available, e.g. through clear-channel assessment (CCA) for a determined time period, e.g. a point coordination function inter-frame space (PIFS) duration before the start of the TXOP.

A virtual carrier sensing function is provided by the provision of a network allocation vector (NAV) which is used to reserve a channel for the duration of the TXOP. Most of the transmitted frames comprise a duration field which can be used to reserve the medium, or provide duration of the NAV protection, for the duration indicated by the value of the duration field. In practice, the NAV is a timer that indicates the amount of time the medium will be reserved. In a typical operation, the transmitting and receiving stations (STAs) will set the NAV to the time for which they expect to use the medium while other STAs count down from the NAV to zero before starting the channel contention. The virtual carrier sensing function indicates that the medium is busy when NAV is non-zero and idle when NAV is zero. The NAV may be set to protect frame transmissions. The communication devices obtain the NAV on the primary channel of the BSS.

As already indicated above, some channel reservation mechanisms may be based on a coordinated channel access mechanism for mesh networks, e.g. mesh BSSs. Such a channel access mechanism for the mesh networks may be used as an additional and optional coordination function called mesh coordination function (MCF), and it may be applied exclusively to the mesh BSSs. The MCF may have both a contention-based channel access and a contention-free channel access mechanism. The contention-based mechanism may be EDCA and the contention-free mechanism may be called a MCF coordinated channel access (MCCA) that optimizes frame exchanges in the mesh BSS.

Under the MCF, the basic unit of allocation of the right to transmit is the TXOP. Each TXOP is defined by a starting time and a defined maximum length. Under the MCF, there are two types of TXOPs: EDCA TXOPs and MCCA TXOPs. The EDCA TXOP is obtained by a mesh STA winning an instance of an EDCA contention. The MCCA TXOP is obtained by a mesh STA gaining control of the transmission medium during an MCCA opportunity MCCAOP. The MCCAOP may be defined as an advance reservation of a time interval for its transmission by means of an MCCA Opportunity Reservation.

The MCCA is an optional access method that allows mesh STAs that implement MCCA to access the transmission medium at selected times with lower contention than would otherwise be allowed. MCCA may be used by a subset of mesh STAs in a mesh BSS.

The mesh STA transmitting an MCCAOP Setup Request frame to initiate an advance reservation is the MCCAOP owner of the MCCAOP reservation defined in this setup. The receivers of the MCCAOP Setup Request are the MCCAOP responders. The MCCAOP owner and the MCCAOP responders advertise this advance reservation to their neighbors via MCCAOP Advertisements. The MCCA-enabled neighbor mesh STAs that could cause interference to transmissions during these reserved time periods, or that would experience interference from them, shall not initiate a transmission during these reserved time periods. During its MCCAOP, the MCCAOP owning mesh STA obtains a TXOP by winning an instance of EDCA contention. Because of its advance reservation, the MCCAOP owning mesh STA experiences no competition from other MCCA-enabled neighbor mesh STAs. At the start of an MCCAOP, the EDCA of the MCCAOP owner replaces an arbitration inter-frame space number (AIFSN) and contention window parameters CWmin and CWmax of its dot11EDCATable with MCCA access parameters. In order to use MCCA, a mesh STA maintains synchronization with its neighboring mesh STAs.

In an embodiment, a reservation allocation vector (RAV) mechanism is applied on the basis of the channel reservation information, and reservation allocation vector protection has similar functionalities as the NAV but is logically different indicator for the channel reservation. The RAV may be set in connection with the advance or preliminary negotiation about the channel reservation, e.g. through the MCCAOP Setup Request Frame. Below, further embodiments related to the RAV are discussed.

Let us now consider an embodiment for carrying out channel reservation with reference to FIGS. 2A and 2B. FIG. 2A illustrates the operation from the point of view of a reserving device, while FIG. 2B illustrates the operation from the point of view of a target device with which the reserving device intends to carry out data transfer. The devices may be any one of the wireless communication devices 100 to 114 of FIG. 1A. Referring first to FIG. 2A, the process starts in block 200. In block 202, a channel reservation procedure is initiated in the reserving device. In block 204, the reserving device is configured to transmit during the channel reservation procedure a reservation request message comprising information elements specifying at least one secondary channel being reserved and a communication direction for at least one channel being reserved. The reservation request message may be addressed to an individual address of the target device, to individual addresses of multiple target devices, or to a group address used in a groupcast or broadcast transmission. In block 206, upon completed reservation procedure, the reserving device is configured to utilize the reserved at least one secondary channel in wireless communication with the target device and in the communication direction specified in the reservation request message.

Let us now consider the operation from the point of view of the target device with which the reserving device intends to communicate. Referring to FIG. 2B, the process in the target device starts in block 210. In block 212, a reservation request message comprising information elements specifying at least one secondary channel being reserved and a communication direction for at least one channel being reserved is acquired. It may be received through a radio interface from the reserving device. In block 214, the received reservation request is processed, and it is checked for any conflicting reservations in said, comprising of at least one secondary channel being reserved. In block 216, the target device is caused to transmit a reservation response message indicating a conflicting reservation and optionally a conflicting channel or channels, if said conflicting reservation has been detected. In some embodiments, the target device may propose an alternative timing or alternative channels that result in a non-conflicting reservation in the reservation response message. If the target device detects no conflicting reservations, the target device may indicate in the reservation response message that no conflicting reservations were detected on the requested channels. In block 218, upon completed reservation procedure, the target device is configured to utilize the reserved at least one secondary channel, wherein no conflict was detected, in wireless communication in the communication direction specified in the reservation request message.

While the above-described processes relate to an embodiment comprising the reservation of the secondary channels and specifying the transmission direction on the secondary channels being reserved, it should be understood that these two features are not essential with respect to each other. Therefore, an embodiment comprises the reservation of the secondary channels without specifying the transmission direction, while another embodiment comprises specifying the transmission direction without the reservation of the secondary channels.

Embodiments of the present invention enable explicit reservation of the secondary channels. In some cases, this may improve the performance of the communication system by reducing the probability of conflicting transmissions on the secondary channels. Furthermore, as the transmission direction may be specified for the secondary channels, it may be possible to specify a channel to be used to transmit acknowledgment messages, for example, as will be described in greater detail below. Therefore, a sub-band of the bandwidth used to transmit payload data may be selected for the acknowledgment, and there is no need to reserve the full bandwidth for the acknowledgment. Some embodiments may improve the system resource utilization and/or throughput.

The above-described channel reservation procedure may be understood as a preliminary channel reservation procedure preceding a transmission on at least one reserved channel. The transmission may then trigger actual channel reservation, and the transmission may contain a data frame, a management frame, and/or a control frame. An example of the control frame is a request-to-send message. The preliminary channel reservation may limit channel reservation options of other communication apparatuses. As a consequence, the preliminary channel reservation reduces a channel contention for the subsequent actual transmission, because it reduces the probability of overlapping reservations.

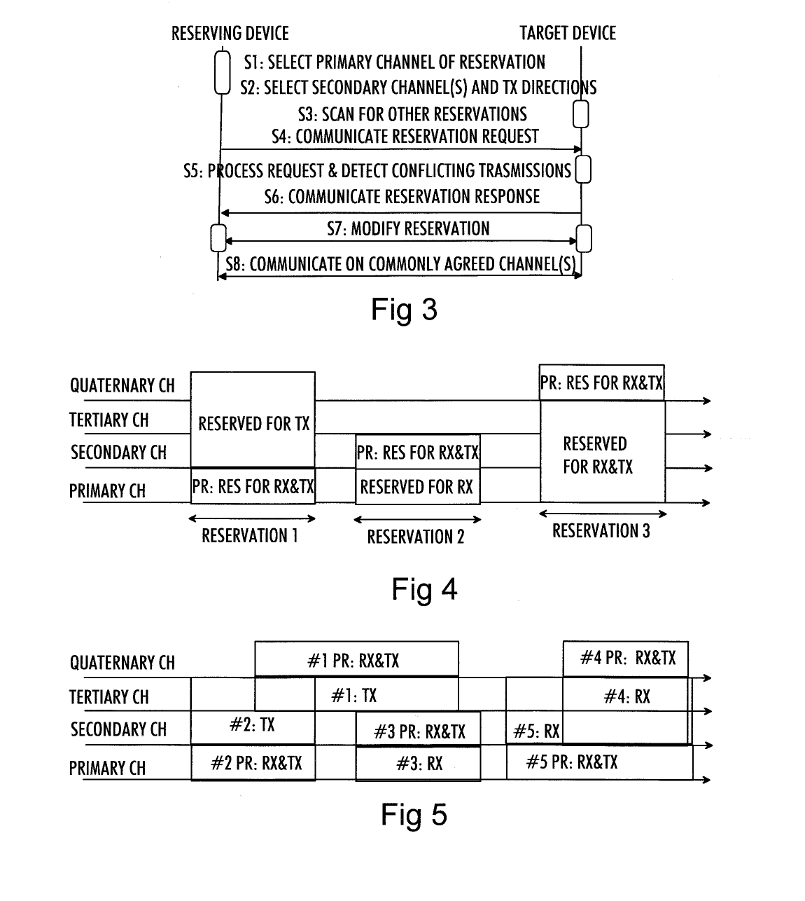

Let us now consider embodiments of the invention with reference to a signalling diagram of FIG. 3. FIG. 3 illustrates a channel reservation procedure where the reserving device and the target device negotiate about the reservation of the secondary channel(s). The reserving device and the target device may be wireless communication apparatuses of different BSSs or the same BSS, e.g. the apparatuses 100 to 104 or 110 to 114 of FIG. 1A. Referring to FIG. 3, the reserving device carries out in S1 a selection procedure in which the reserving device selects a primary channel of reservation. Primary channel of reservation may be understood as a primary channel for at least one of channel access, connection control, and data transmission with respect to the reservation in question. The other channels of the reservation may be secondary channels that may be understood as additional channels for data transmission. Some channel access functionalities may be performed also on secondary channel(s). The primary channel of reservation may be the primary channel of the BSS, but in other embodiments the reserving device may select the primary channel of reservation to be another channel. For example, an access point may be configured to use the primary channel of the BSS as the primary channel of reservation, but a terminal station wishing to transfer data directly with another terminal station may use another channel as the primary channel of reservation. The infrastructure network requires that non-AP STAs transmit and receive via the AP, unless the terminals have established direct links. The reservations by the AP may be made on the primary channel of the BSS. However, the AP may use another primary channel of reservation if all the terminal stations associated with the AP operate in a reservation-enabled state, wherein the terminal stations independently monitor the secondary channel(s) for reservations and/or for reservation advertisements being broadcasted by the AP and other terminal stations of the BSS and/or other BSSs. In the independent or mesh BSSs or mesh networks, the devices may transmit traffic directly to each other. The mesh STAs may carry out reservations on a different channel than the primary channel of the mesh BSS. The different channel may be used as the primary channel of reservation, for example, if all mesh STAs of the mesh BSS operate in the above-mentioned reservation-enabled state and/or if the devices of the mesh BSS not in the reservation-enabled state are in a sleep mode or in another mode that effectively avoids conflicting transmissions.

The primary channel of reservation selected in S1 may be a static or a semi-static parameter that needs not to be reselected in connection with initiation of a periodically repeating reservation (see Table 1 below). Upon selecting the primary channel of reservation, the reserving device selects secondary channel(s) to be reserved for the transmission and associated transmission directions in S2. The reserving device may select the transmission direction individually for each channel to be reserved. In some embodiments, the primary channel of reservation is dedicated to both transmission and reception, while the other channels may be used for transmission, reception, or transmission and reception, as deemed necessary. Therefore, flexibility is achieved.

Meanwhile, a target device may carry out scanning for channels of the BSS for reservations and transmissions in S3. Upon detection of an advertisement of a reservation, the target device may extract from the advertisement at least the channel(s), associated transmission direction(s) of the reservation, and the duration of the reservation. As a consequence, the target device (and each device of the BSSs) stores knowledge of on-going reservations, their durations and channels, and the transmission direction(s) on each channel. The reserving device may utilize such information it has previously acquired from a similar scanning process when selecting the channels in S2 so as to carry out a reservation that is not in conflict with another prevailing reservation.

In S4, the reserving device transmits the reservation request to the target device. The reservation request may be realized by a reservation setup request frame that is a management frame addressed to the target device with which the channel reservation is being carried out. The reservation request message may define the parameters of the requested reservation, and it may comprise at least some of the information elements illustrated in Table 1 below.

TABLE 1

| | | | | Reservation | |
|---|---|---|---|---|---|
| | Reser- | Reser- | | Primary | System- |
| | vation | vation | Reservation | Channel | Specific |
| Field | Duration | Offset | Periodicity | Offset | Information |
| Octets | 1 | 3 | 1 | 1 | 4 |

The reservation duration field specifies the intended duration of the reservation. The length of the field may be one octet, and it may contain an unsigned integer. The integer may specify the duration of the reservation in multiples of a time period, e.g. 32 us.

The reservation offset field may define the beginning of the reservation in the time domain. In some embodiments where the beginning of the reservation is in effect triggered immediately by the detection of the reservation request message, the reservation offset field may contain a value of zero. The offset may be bound to a determined timeline so as to enable a common timing basis for all devices to which the reservation may concern. A Delivery Traffic Indication Map (DTIM) interval may be used as such a timing basis. The DTIM is a special type of traffic indication map (TIM) which occurs with a lower frequency, according to the DTIM interval, whereas the TIMs are transmitted with every beacon. The DTIM transmissions enable a device in a power-save mode to receive broadcast and multicast frames. Generally, frames with a group address cannot be delivered by using the polling mechanism used in connection with the unicast frames. Therefore, the DTIM transmissions solve the problem of reaching the devices in the power-save mode. The DTIM interval indicates the number of beacon intervals between DTIM transmissions and may be the DTIM interval of the BSS to which the reserving device belongs. The length of this field may be three octets.

The reservation periodicity field (one octet) may specify how many reservations of the defined duration are comprised within the DTIM interval. The reservation may be divided with equal intervals over the DTIM interval starting from the time instant specified by the reservation offset. The sum of the reservation offset and the reservation duration may be constrained to be smaller than the duration of the DTIM interval divided by Reservation Periodicity so that all the reservations fit into the DTIM interval.

The system-specific information may comprise the following fields of Table 2:

TABLE 2

| | | RX | TX | Group | | ID Re- | Reser- |
|---|---|---|---|---|---|---|---|
| | Re- | Band- | Band- | ID | Group | serving | vation |
| Field | served | width | width | info | ID | Device | ID |
| Bits | 3 | 2 | 2 | 2 | 6 | 9 | 8 |

The RX bandwidth field (two bits) indicates the bandwidth the reserving device intends to reserve for reception during the reservation. Two bits are necessary to indicate one to four possible bandwidths (e.g. 20 to 160 MHz).

The TX bandwidth field (two bits) indicates the bandwidth the reserving device intends to reserve for transmission during the reservation. The following coding of the two bits to indicate the reserved bandwidth for transmission/reception may be used (obviously, other notations may be used):

TABLE 3

| Value | Bandwidth [MHz] |
|---|---|
| 00 | 20 |
| 01 | 40 |
| 10 | 80 |
| 11 | 160 |

The group identifier (ID) field may be used to indicate a group ID of a data packet, e.g. a physical protocol data unit (PPDU), associated with the reservation. This may be used to associate the reservation to the data transmission that utilizes that reservation. With respect to associating the PPDU to the reservation, the PPDU may comprise an information element in a header of the PPDU, wherein the information element indicates whether or not the PPDU relates to a reservation. Such an information element may be comprised in a Very High Throughput (VHT) Sig A field of the IEEE 802.11ac. For example, the group ID a partial association identifier (AID) of the number of space time streams (Nsts) field may be used to associate the identifier of the PPDU to the reserving device.

The Group ID info field may be reserved for legacy transmissions, and state-of-the-art procedures may be applied to the Group ID info field.

The ID of the reserving device is included in the ID reserving device field. It may comprise a partial identifier of the reserving device or a full identifier. In some embodiments, the field may comprise a partial Association ID of the reserving device, e.g. when a single-user-multiple-input-multiple-output (SU-MIMO) communication is being reserved. For example, the partial Association ID may be used when an AP transmits to an associated non-AP STA, or when a non-AP STA transmits to a peer STA with which a direct link setup (DLS) or Tunneled direct link setup (TDLS) has been carried out. Otherwise, a determined number (e.g. nine) of the least significant bits of a MAC (Medium Access Control) address of the reserving device may be included in the field. In the case of SU-MIMO transmissions, the group ID together with the ID reserving device field may be used to associate the data transmission to the reservation.

The reservation ID may comprise an identifier of the reservation. However, the reservation ID may be reused. In some embodiments, the combination of the reservation ID, Group identifier, and the ID of the reserving device are unique for each reservation request message.

Upon reception of the reservation request message in S4, the target device processes and extracts the contents of the reservation request message. In S5, the target device processes the request by checking its reservation database for conflicting reservations and/or on-going transmissions. The target device may be configured to check for any overlapping reservations according to some embodiments. However, even overlapping reservations may be allowed according to rules defined below. The checking is made by comparing the channels specified in the reservation request message against the current reservations and transmissions observed by the target device. The radio environment of the target device may be different from the radio environment of the reserving device and, thus, the target device may have detected reservations and/or transmissions not detected by the reserving device. Upon completing S5, the target device transmits in S6 a reservation response message to the reserving device. The reservation response message may be a reservation setup response frame which is also a management frame transmitted to the address of the reserving device (the transmitter of the reservation setup request frame). The reservation response message may comprise the following fields of Table 4.

TABLE 4

| Order | Information |
|---|---|
| 1 | Reservation Info |
| 2 | Success |

The Reservation Info field may comprise the following information elements:

TABLE 5

| | Setup | Setup | Overlapping | First | |
|---|---|---|---|---|---|
| | Condition | Condition | transmissions | Conflicting | |
| Field | for RX | for TX | present | Channel | Reserved |
| Bits | 1 | 1 | 1 | 4 | 1 |

The setup condition fields (one bit) may specify whether or not the requested reservation may be fulfilled for reception and transmission, respectively. The Setup Condition for RX field may be set to 1 to indicate that all channels requested to be reserved for reception are available in the target device (0 otherwise). The Setup Condition for TX field is set to 1 to indicate that all channels requested to be reserved for transmission are available in the target device (0 otherwise).

The Overlapping Transmissions present field (one bit) may be used to indicate whether or not there is an overlapping reservation and/or transmission. It should be noted that an overlapping reservation/transmission may be indicated while indicating successful reservation for both transmission and reception, if the overlapping reservation is deemed not to collide with the reservation (see rules for making overlapping reservations below). This field may be set to 1 to indicate that the requested device observes other reception and/or transmission reservations that use the same resources as the reservation (0 otherwise).

The First Colliding Channel field may be used to indicate the channels that cannot be reserved. It may be set to 0 to indicate that all requested channels may be reserved successfully. Values 1-15 may indicate the first channel of the requested channels in which the reservation condition was not met.

The Success field of Table 4 may comprise at least some of the following information elements:

TABLE 6

| Value | Reason |
|---|---|
| 0 | Success |
| 1 | Collision on Primary channel of BSS |
| 2 | Collision on requested channels |
| 3 | Target device has another overlapping |
| | reservation at the same time |
| 4 | Unspecified error |
| 5-255 | Reserved |

Upon reception of the reservation response message in S6, the reserving device may determine the contents of the response. Upon fully or partial successful reservation, the reserving device may transmit an advertisement message to indicate the verification of the reservation. Such an advertisement message may be a reservation advertisement frame used to inform the advertisement-enabled devices about the reservation. The reservation advertisement frame may comprise the following fields of Table 7:

TABLE 7

| | Number of RX | | Number of TX | | Number of RX | RX | Number of TX | TX |
|---|---|---|---|---|---|---|---|---|
| | Time | RX Time | Time | TX Time | Interference | Interference | Interference | Interference |
| Field | reports | Reports | Reports | Reports | Reports | Reports | Reports | Reports |
| Octets | 1 | Variable | 1 | Variable | 1 | Variable | 1 | Variable |

The number of reports fields each comprises an unsigned integer that indicates the number of reservation report fields in the report. The reservation advertisement frame comprises the following reservation report fields:

The RX Time Reports field contains the time instants and the channels in which the advertising device itself carries out reception.

The TX Time Reports field contains the time instants and the channels in which the advertising device itself carries out transmission.

The Interference RX Reports field contains the time instants and channels in which the advertising device has detected a reservation for a reception by another device.

The Interference TX Reports field contains the time instants and channels in which the advertising device has detected a reservation for a transmission by another device.

Referring back to FIG. 3, upon reception of a reservation response message indicating unsuccessful reservation on at least some of the channels requested for reservation, the reserving device may in S7 modify the reservation parameters, e.g. channel, transmission direction, and duration, and transmit another reservation request message which is processed in the target device in the above-described manner. The modified reservation request may be transmitted in the format of the above-mentioned reservation setup request frame. However, S7 may be omitted and a new reservation may be carried out. Upon at least partially successful reservation, the reserving device and the target device transfer data on the reserved channel(s) in S8.

In some embodiments, the wireless communication apparatus is configured to have only a single reservation at a time.

FIG. 4 illustrate some reservation arrangements that may be achieved according to the above-described channel reservation principles. FIG. 4 illustrates the primary channel and the secondary channels of the BSS. With respect to reservation 1 in FIG. 4, the reserving device may select the primary channel of the BSS as the primary channel of reservation, denoted as PR, and transmit the reservation message on the primary channel. The primary channel is also reserved for both transmission and reception. Additionally, the reserving device may explicitly specify the secondary to quaternary channels to be reserved for transmission only. With respect to reservation 2 in FIG. 4, the reserving device may select the secondary channel as the primary channel of reservation and transmit the reservation message on the secondary channel. This primary channel of reservation is also reserved for both transmission and reception. Additionally, the reserving device may explicitly specify the primary channel of the BSS to be reserved for reception only. With respect to reservation 3 in FIG. 4, the reserving device may select the quaternary channel of the BSS as the primary channel of reservation and transmit the reservation message on that channel. The quaternary channel is also reserved for both transmission and reception. Additionally, the reserving device may explicitly specify the primary to tertiary channels to be reserved for both transmission and reception. Accordingly, the reserving device may allocate the primary channel of reservation for both transmission and reception by default, and it may select any one of the remaining channels of the BSS individually, partially, or wholly to be used for transmission, reception, or both.

Let us now consider the above-mentioned rules for reserving the channels for each transmission direction. The principle may be that a new overlapping transmission is allowed if it is not detectable in a receiver of a previous reservation. Accordingly, the following rules may be applied to allow the overlapping reservations. A channel may be reserved for both transmission and reception if: (i) the reserving device and the target device do not conduct an overlapping transmission or reception on the channel during the intended reservation; (ii) the reserving device and the target device do not detect an interfering transmission or reception on the channel during the intended reservation; and (iii) the reserving device and the target device do not have another reservation during the intended reservation.

The channel may be reserved for the transmission (transmission only) if: (i) the reserving device (the transmitter) does not detect any advertisement indicating reception operation on the channel during the intended reservation; (ii) the target device does not indicate interfering transmission on the channel during the intended reservation; and (iii) the reserving device and the target device do not have another reservation during the intended reservation.

The channel may be reserved for the reception (reception only) if: (i) the reserving device (the receiver) does not detect any advertisement indicating transmission operation on the channel during the intended reservation; (ii) the target device does not indicate interfering reception on the channel during the intended reservation; and (iii) the reserving device and the target device do not have another reservation during the intended reservation.

In summary, the transmission from the reserving device to the target device is allowed on the same channel as another transmission, if that transmission is not interfered by any third party reception and if the reception by the target device is not interfered by any third party transmission. The same principle applies to the transmission from the target device to the reserving device. Within these rules, the reservation overlapping with another reservation known by the reserving device and/or the target device may be allowed. Let us consider some examples of overlapping reservations with reference to FIG. 5. Referring to FIG. 5 a first reservation #1 relates to reserving the quaternary channel of the BSS for transmission and reception, which is the primary channel of reservation, and the tertiary channel for transmission only. A second reservation #2 relates to reserving the primary channel of the BSS for the transmission and reception, which is the primary channel of reservation, and the secondary and tertiary channels for the transmission only. Now, there is an overlapping reservation on the tertiary channel between #1 and #2. This is, however, allowed if the transmission on the tertiary channel of reservation #1 cannot be detected by the receiver of reservation #2 on the tertiary channel. A third reservation #3 on the primary and the secondary channel does not overlap with any other reservation. A fourth reservation #4 shares the same channels for reception with a fifth reservation #5 on the secondary and tertiary channels. However, the overlapping reservation is allowed if the transmissions do not interfere with each other, e.g. in this case where there is no third party transmission on the secondary and tertiary channels.

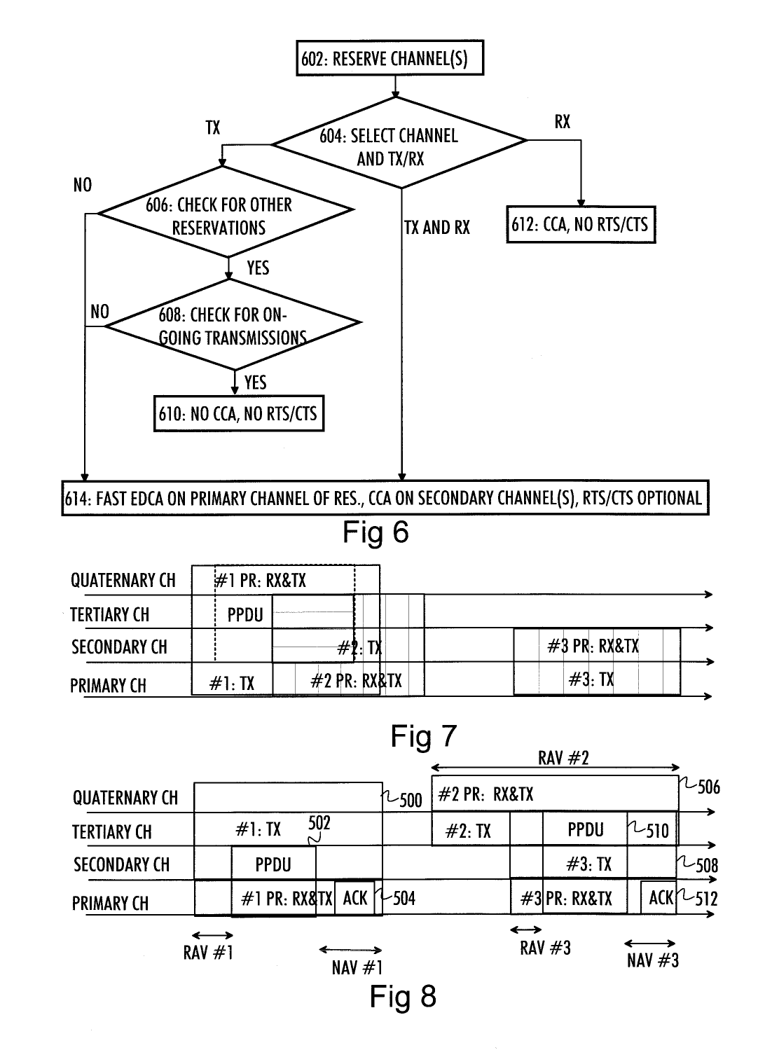

Let us now consider channel access principles with respect to the data transmission on the reserved channel(s) with reference to the flow diagram of FIG. 6. Depending on the transmission direction and whether or not there is an overlapping reservation, different channel access principles may be utilized. When only a single reservation is present for a channel, the reserving device obtains a TXOP on the primary channel of the reservation with EDCA parameters that enable fast TXOP obtaining. The reserving device may even select EDCA parameters that relate to a higher priority access class than the actual data being transferred in order to speed up the TXOP obtaining. A clear channel assessment (CCA) may be carried out for the other channels of the reservation, and the TXOP may be initiated if those channels are free for a PIFS duration. The channel access rules may thus be the same as in conventional EDCA. In this case, the channels may be used for transmission and/or reception.

When there is an overlapping reservation, the procedure of FIG. 6 may be used. The procedure of FIG. 6 may be carried out by the reserving device or the target device, depending on the transmission direction. In other words, an apparatus carrying out the process may carry out some steps in the role of the reserving device, while it may carry out other steps in the role of the target device. Let us assume that the channel(s) has/have already been reserved in block 602 according to any one of the above-described principles. In block 604, the reserving device selects one of the reserved channels. If the channel is reserved for transmission only, the process proceeds to block 606 to check for overlapping reservations allocated to the channel. This may be carried out by checking whether or not there is a RAV set by another device and whether or not such a RAV overlaps with the reservation of the reserving device. If at least one overlapping reservation is detected, then the reserving device proceeds to block 608 to check for on-going transmissions. This may be carried out by checking whether or not there is a NAV set by another device and whether or not such a NAV overlaps with the reservation of the reserving device. Block 608 may be an optional feature that can be configured by using the management information base. Upon the detection of an ongoing transmission, the reserving device carries out no channel contention (block 610), no CCA, or any other channel access verification/contention, because the reserving device knows that the overlapping reservation does not interfere with its transmission. The reserving device may rely on that all devices using the channel are bound by the above-mentioned rules for carrying out reservations. As a consequence, the channel contention rules may be skipped, which speeds up the TXOP obtaining. However, in some embodiments, the reserving device may carry out at least one of the following procedures: 1) check whether or not there is a prevailing NAV protection on the channel that prevents transmission; 2) carry out the CCA on the channel. If any one of the processes indicates a conflicting transmission or reservation, the transmission by the reserving device may be prevented. If no other reservations or transmissions were found in blocks 606 and 608, respectively, the process proceeds to block 614 in which the reserving device may perform fast EDCA procedures with backoff calculation on the primary channel of reservation.

On the other hand, if the channel is reserved for both transmission and reception, the process proceeds from block 604 to block 614 in which the reserving device carries out the fast EDCA procedures with backoff calculation on the primary channel of reservation. Overlapping reservations may be configured to have different primary channels of reservation so that the above-mentioned rules are fulfilled. The EDCA parameters (the backoff parameters, the arbitration interframe space number, and the duration of the TXOP) may be specific to the appropriate access class or to a reservation scheme. The EDCA parameters may also be configured in a manner to support the above-mentioned fast EDCA procedures. For example, the backoff parameters which comprise the minimum and maximum contention window size could be selected so as to influence the average time required to successfully deliver a packet. For example, a shorter contention window size may be selected for a high priority data packet and a longer contention window size may be selected for a low priority data packet. The arbitration interframe space number could be used to determine the time duration the reserving device needs to perform carrier sensing. The TXOP limit parameter could be used to specify the time duration a STA may transmit after it has acquired the TXOP. Hence, a higher access class may prioritize its channel access by reducing backoff parameters and/or arbitration interframe space number, and even maintain longer control of the channel by increasing the TXOP limit. Similarly, a STA with an impending channel reservation for transmission may prioritize its channel access by using the fast EDCA procedures during that reservation interval. If the selected channel is not the primary channel of reservation, the CCA may be performed on the channel for the PIFS duration before the TXOP initiation (if the channel is sensed to be idle). The reserving device and the target device may also verify the availability of the channels for transmission by using a handshake in which the reservation device transmits a request-to-send (RTS) message specifying the reserved channels to the target device. If the target device detects that the channels are idle, it may transmit a clear-to-send (CTS) message specifying the reserved channels. However, if a subset of reserved channels is detected as busy, the target device may specify only those channels that are still available. The RTS/CTS handshake also initiates the NAV protection on the channels specified in at least the CTS message.

If the channel is reserved for reception only, the process proceeds from block 604 to block 612. Block 612 is carried out by the target device. In block 612, the target device carries out the CCA on the channel for the PIFS duration. If the channel is sensed to be free, the TXOP is obtained. According to an embodiment, no RTS/CTS handshake is carried out in order not to interfere overlapping reservations. Similarly, the RTS/CTS handshake may be prevented in block 610. In blocks 610 to 614, the reserving device may also carry out the CCA on at least one channel that was not included in the reservation, and if the channel is detected to be idle for the determined duration (e.g. PIFS), the TXOP may be expanded to the channel. Such a channel is preferably one of the secondary channels of the BSS.

FIG. 7 illustrates another point of view of the channel access procedure with overlapping reservations. Let us assume overlapping reservations #1 and #2, as shown in FIG. 7. The reservations have an overlapping reservation for the transmission direction on the secondary and tertiary channel, and a PPDU is transmitted in relation to the reservation #1. As a consequence a reserving device of reservation #2 is configured to apply the fast EDCA procedures according to block 614 when its reservation #2 does not overlap with the reservation #1 and when its reservation #2 overlaps with the reservation #1 but when there is no on-going transmission with respect to the reservation #1 (see vertical lining in FIG. 7). With reference to FIG. 6, this corresponds to detecting the reservation in block 606 but detecting no on-going transmission in block 608 and, thus, block 614 is executed. On the other hand, when both overlapping reservation and on-going transmission has been detected in respective blocks 606 and 608 (see horizontal lining in FIG. 7), block 610 is executed where no channel contention is carried out, and the CCA may be omitted according to block 610, or the CCA may be carried out. With respect to reservation #3, there are no overlapping reservations, so the process proceeds from block 606 directly to block 614 to perform the fast EDCA procedures on the primary channel of reservation and the CCA on the secondary channel(s).

The channel reservation may trigger a reservation allocation vector (RAV) which may indicate the duration of the intended reservation to the other devices receiving the reservation request message, the reservation response message, and/or the reservation advertisement message. The RAV may have properties similar to the NAV, e.g. it may prevent subsequent overlapping reservations of the channel(s) unless they fulfill the above-mentioned rules. However, as already mentioned above, the RAV relates to the preliminary reservation of the channel, while NAV typically relates to actual utilization of the channel. Furthermore, the RAV may be set as a semi-static parameter that may be set to start in a defined time point in the future and it may be repeated in a predefined manner, while the NAV is triggered immediately upon transmission of an appropriate message, e.g. RTS, CTS, or PPDU. The RAV parameters, e.g. start time, duration, and periodicity, may be specified in the reservation request message, as described above.

Let us now consider the channel protection by the RAV and the NAV with reference to FIG. 8. Let us first consider a non-overlapping reservation #1 indicated by numeral 500. The primary channel of the BSS may be the primary channel of reservation, while the secondary channels are reserved for transmission only. The RAV is triggered to the reservation by the contents of the reservation advertisement message, for example, and the RAV may extend initially to cover the whole reservation 500. The RAV may be cancelled by the owner or responder of the reservation upon the transmission of any message that triggers the NAV protection, and the NAV ensures the channel protection from there on. Such a message may a data packet (PPDU) 502, as illustrated in FIG. 8. It may, however, be another message, e.g. a CTS-to-self message. The CTS-to-self message may be addressed to the reserving device, thus making it a “to-self” message. The CTS-to-self message may indicate the reserved channels or a subset of reserved channels and the duration of the reservation. This may set the boundaries for the NAV protection. The NAV protection may be extended to cover the rest of the reservation duration, including any subsequent messages such as the acknowledgment messages 504. The conversion of the RAV to NAV on a subset of reserved channels may be configured to remove the RAV protection from those channels that are not covered by the NAV. As a consequence, any wireless communication apparatus obeying the RAV and detecting the NAV on the subset of reserved channels may set the NAV on appropriate channels and release the RAV restriction from the other channels. Thus, it may attempt to reserve the remaining (RAV-released) channels for its own use.

With respect to the right hand side of FIG. 8, a second reservation #2 506 has reserved the quaternary channel of the BSS for transmission and reception (the primary channel of reservation) and the tertiary channel for transmission only. Accordingly, appropriate RAV is set for the duration of the reservation. Even though the reserving device of #2 does not utilize the reserved resources, the RAV may be maintained on the channels to prevent other conflicting reservations. A third reservation #3 508 reserves the primary channel of the BSS for the transmission and reception, which is the primary channel of reservation, and the secondary and tertiary channels for transmission only. A PPDU 510 belonging to the third reservation #3 is transmitted on the reserved channels, thus converting the RAV to NAV on all channels of that reservation to protect the PPDU and its acknowledgment 512. It should be noted that if the second reservation #2 was utilized for transmission, there could be two overlapping NAVs on the tertiary channel without any conflicting transmissions. In this case, the legacy devices may update their NAV to the longer of these two durations. All the reservations may be made within the same BSS or within a plurality of overlapping BSSs. The overlapping may refer to an overlapping a coverage area.

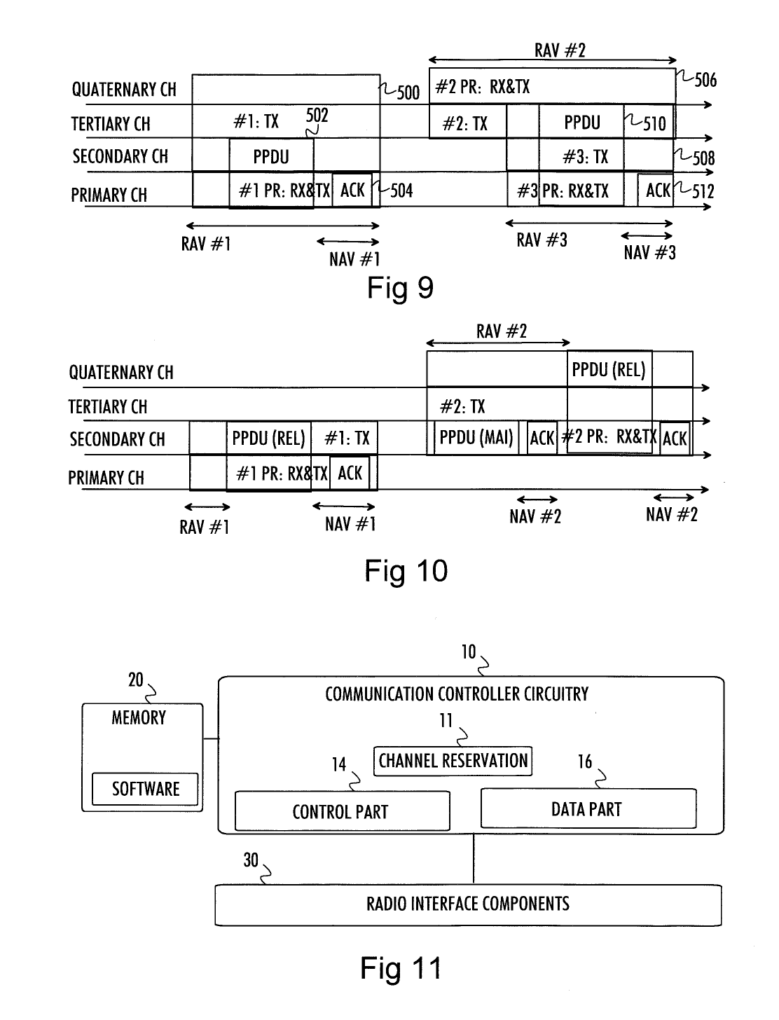

FIG. 8 illustrates an embodiment where the RAV is cancelled by the NAV, and the NAV effectively protects the reserved channel(s) from there on. However, in other embodiments, the RAV is not cancelled by the transmission of the PPDU or any other message. In such embodiments, the RAV may last on a channel for the duration of the initial reservation even though the data transmission is carried out on the channel. As a consequence, both RAV and NAV may be present concurrently on the channel. This enables even better protection of the transmissions on the channel. FIG. 9 illustrates such an embodiment with the same channel reservations as in FIG. 8.

FIG. 10 illustrates another embodiment in which the RAV is explicitly cancelled by signalling a ‘Release RAV’ message in a physical layer convergence protocol (PLOP) header of the transmitted PPDU. Referring to FIG. 10 and the first reservation #1, the reserving device has reserved the channels for a given duration, and the RAV may be set to affect the reservation for the duration. The reserving device the gains the TXOP on the primary and the secondary channels and transmits a PPDU on those channels. The PPDU may comprise a PLOP header with an information element that explicitly cancels the RAV for that reservation. The information element may be a single bit indicating the “Release RAV”. As a consequence, the duration of the RAV is effectively cancelled before the end of the reservation. As mentioned above, the NAV protection will come into effect upon the successful reception of a MAC header of the PPDU which contains information about the duration of NAV protection. As a consequence, the PPDU and a subsequent acknowledgment message are now protected by the NAV instead of the RAV. In an embodiment, the RAV is cancelled by the explicit indication in the PLOP header when the reserving device gains the TXOP on all channels included in the reservation.

Now referring to the second reservation #2 of FIG. 10, the reserving device is not able to obtain TXOP on all the reserved channels at first. Since no overlapping reservation is detected, the reserving device may perform the fast EDCA procedures according to block 614. Let us assume that the tertiary and quaternary channels are sensed as busy during the CCA, the reserving device may then choose to maintain the RAV protection by indicating ‘Maintain RAV’ in the PLOP header of the PPDU transmitted on the primary channel of reservation on which the first TXOP was obtained. In the subsequent TXOP, the reserving device successfully acquires the access to the remaining channels, and it may cancel the remaining RAV protection accordingly with the “Release RAV” indication in the PLOP header. This procedure improves control of RAV protection and provides opportunities for the reserving device to acquire larger transmission bandwidth within a single reservation.

FIG. 11 illustrates an embodiment of an apparatus comprising means for carrying out the above-mentioned functionalities of the reserving device and/or the target device. The apparatus may be a communication apparatus of an IEEE 802.11 network or another wireless network, e.g. an AP or STA. The apparatus may also be a cognitive radio apparatus capable of adapting its operation to a changing radio environment, e.g. to changes in parameters of another system on the same frequency band. The apparatus may be a computer (PC), a laptop, a tabloid computer, a cellular phone, a palm computer, a fixed base station operating as the AP, or any other apparatus provided with radio communication capability. In another embodiment, the apparatus is comprised in such a communication apparatus, e.g. the apparatus may comprise a circuitry, e.g. a chip, a processor, a micro controller, or a combination of such circuitries in the communication apparatus.

The apparatus may comprise a communication controller circuitry configured to control the communications in the communication apparatus. The communication controller circuitry 10 may comprise a control part 14 handling control signalling communication with respect to transmission, reception, and extraction of control frames including the reservation request messages, the reservation response messages, and the reservation advertisement messages, as described above. The communication controller circuitry 10 may further comprise a data part 16 that handles transmission and reception of payload data during transmission opportunities of the communication apparatuses (transmission) or transmission opportunities of other communication apparatuses (reception). The communication controller circuitry 10 may further comprise a channel reservation controller circuitry configured to carry out at least some of the channel reservation procedures described above. The channel reservation circuitry 11 may carry out the selection of the primary channel of reservation, determine channels to be reserved, control transmission of the reservation request messages, processing of the received reservation response messages, control transmission and processing of the reservation advertisement messages, control the data transmission/reception in the reserved resources, etc. in the above-described manner. The channel reservation circuitry may also control monitoring for the other reservations and transmissions. Upon reception of a reservation advertisement message through the control part 14, the channel reservation circuitry 11 may extract the reservations indicated in the reservation advertisement message and store the information of the reservation. The stored information of other reservations may then be used as an input in the channel selection in S1 and S2 when the channel reservation circuitry 11 carries out the channel reservation.

The circuitries 11 to 16 of the communication controller circuitry 10 may be carried out by the one or more physical circuitries or processors. In practice, the different circuitries may be realized by different computer program modules. Depending on the specifications and the design of the apparatus, the apparatus may comprise some of the circuitries 11 to 16 or all of them.

The apparatus may further comprise the memory 20 that stores computer programs (software) configuring the apparatus to perform the above-described functionalities of the communication apparatus. The memory 20 may also store communication parameters and other information needed for the wireless communications, e.g. a database comprising current channel reservations and the channel reservation rules. The apparatus may further comprise radio interface components 30 providing the apparatus with radio communication capabilities within the BSS and/or with other BSSs. The radio interface components 30 may comprise standard well-known components such as amplifier, filter, frequency-converter, (de)modulator, and encoder/decoder circuitries and one or more antennas. The apparatus may further comprise a user interface enabling interaction with the user of the communication device. The user interface may comprise a display, a keypad or a keyboard, a loudspeaker, etc.

In an embodiment, the apparatus carrying out the embodiments of the invention in the communication apparatus comprises at least one processor and at least one memory including a computer program code, wherein the at least one memory and the computer program code are configured, with the at least one processor, to cause the apparatus to carry out the steps of any one of the processes of FIGS. 2A and 2B. In further embodiments, the at least one memory and the computer program code are configured, with the at least one processor, to cause the apparatus to carry out any one of the embodiments related to processing channel reservations, as described above in connection with FIGS. 2A to 10. Accordingly, the at least one processor, the memory, and the computer program code form processing means for carrying out embodiments of the present invention in the wireless communication apparatus.

As used in this application, the term ‘circuitry’ refers to all of the following: (a) hardware-only circuit implementations, such as implementations in only analogue and/or digital circuitry, and (b) to combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) to circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular element, a baseband integrated circuit or applications processor integrated circuit for a mobile phone or a similar integrated circuit in server, a cellular network device, or other network device.

The processes or methods described in FIGS. 2A to 10 may also be carried out in the form of a computer process defined by a computer program. The computer program may be in source code form, object code form, or in some intermediate form, and it may be stored in a transitory or a non-transitory carrier, which may be any entity or device capable of carrying the program. Such carriers include a record medium, computer memory, read-only memory, electrical carrier signal, telecommunications signal, and software distribution package, for example. Depending on the processing power needed, the computer program may be executed in a single electronic digital processing unit or it may be distributed amongst a number of processing units.

The present invention is applicable to wireless telecommunication systems defined above but also to other suitable telecommunication systems. The protocols used, the specifications of mobile telecommunication systems, their network elements and subscriber terminals, develop rapidly. Such development may require extra changes to the described embodiments. Therefore, all words and expressions should be interpreted broadly and they are intended to illustrate, not to restrict, the embodiment. It will be obvious to a person skilled in the art that, as technology advances, the inventive concept can be implemented in various ways. The invention and its embodiments are not limited to the examples described above but may vary within the scope of the claims.

1-36. (canceled)

37. A method, comprising:
initiating, in a communication apparatus, a channel reservation procedure;
causing the communication apparatus to transmit during the channel reservation procedure a reservation request message comprising information elements specifying at least one secondary channel being reserved and a communication direction for at least one channel being reserved; and
upon completed reservation procedure, causing the communication apparatus to utilize the reserved at least one secondary channel in wireless communication in the communication direction specified in the reservation request message.

38. The method of claim 37, further comprising:
specifying, in the reservation request message, transmission or reception as the communication direction; and
causing the communication apparatus to utilize said reserved at least one secondary channel exclusively for transmission or reception, as specified in the reservation request message.

39. The method of claim 37, further comprising before the channel reservation procedure:
detecting a channel reservation by another communication apparatus;
determining a communication direction of the detected channel reservation by the other communication apparatus;
determining that an overlapping reservation does not cause conflict with the detected channel reservation; and
selecting, during the channel reservation procedure, said at least one secondary channel to overlap with at least one channel reserved in the detected channel reservation.

40. The method of claim 39, further comprising selecting the communication direction for the overlapping at least one secondary channel on the basis of the determined communication direction of the detected channel reservation.

41. The method of claim 40, further comprising selecting the communication direction for the overlapping at least one secondary channel to be the same communication direction as the determined communication direction of the detected channel reservation.

42. The method of claim 37, wherein the channel reservation procedure is a preliminary channel reservation procedure preceding a transmission on at least one reserved channel, wherein the preliminary channel reservation limits channel reservation options of other communication apparatuses.

43. The method of claim 37, further comprising specifying, in the reservation request message, a start time, a duration, and a periodicity of the reservations for said at least one secondary channel being reserved.

44. The method of claim 37, further comprising:
specifying, in the reservation request message a plurality of secondary channels being reserved;
specifying, in the reservation request message, a first communication direction to a first subset of the plurality of secondary channels being reserved; and
specifying, in the reservation request message, a second communication direction different from the first communication direction to a second subset of the plurality of secondary channels being reserved.

45. The method of claim 37, wherein a channel set supported in the wireless communication by the communication apparatus comprises a primary channel and at least one secondary channel, the method further comprising:
transmitting the reservation request message on a secondary channel; and
upon the completed reservation procedure, causing the communication apparatus to carry out a channel contention procedure on the secondary channel before utilizing the reserved at least one secondary channel in the wireless communication.

46. A method comprising:
acquiring, in a wireless communication apparatus, a reservation request message comprising information elements specifying at least one secondary channel being reserved and a communication direction for at least one channel being reserved;
checking for any conflicting reservations in said at least one secondary channel being reserved;
causing the wireless communication apparatus to transmit a reservation response message indicating a conflicting reservation, if said conflicting reservation has been detected;
upon completed reservation procedure, causing the communication apparatus to utilize the reserved at least one secondary channel, wherein no conflict was detected, in wireless communication in the communication direction specified in the reservation request message.

47. An apparatus comprising:
at least one processor; and
at least one memory including a computer program code, wherein the at least one memory and the computer program code are configured, with the at least one processor, to cause the apparatus to:
initiating a channel reservation procedure;
cause a wireless communication apparatus to transmit during the channel reservation procedure a reservation request message comprising information elements specifying at least one secondary channel being reserved and a communication direction for at least one channel being reserved; and
upon completed reservation procedure, cause the wireless communication apparatus to utilize the reserved at least one secondary channel in wireless communication in the communication direction specified in the reservation request message.

48. The apparatus of claim 47, wherein the at least one memory and the computer program code are configured, with the at least one processor, to cause the apparatus to:
specify, in the reservation request message, transmission or reception as the communication direction; and
cause the wireless communication apparatus to utilize said reserved at least one secondary channel exclusively for transmission or reception, as specified in the reservation request message.

49. The apparatus of claim 47, wherein the at least one memory and the computer program code are configured, with the at least one processor, to cause the apparatus to:
detect, before the channel reservation procedure, a channel reservation by another communication apparatus;
determine a communication direction of the detected channel reservation by the other communication apparatus;
determine that an overlapping reservation does not cause conflict with the detected channel reservation; and
select, during the channel reservation procedure, said at least one secondary channel to overlap with at least one channel reserved in the detected channel reservation.

50. The apparatus of claim 49, wherein the at least one memory and the computer program code are configured, with the at least one processor, to cause the apparatus to select the communication direction for the overlapping at least one secondary channel on the basis of the determined communication direction of the detected channel reservation.

51. The apparatus of claim 50, wherein the at least one memory and the computer program code are configured, with the at least one processor, to cause the apparatus to select the communication direction for the overlapping at least one secondary channel to be the same communication direction as the determined communication direction of the detected channel reservation.

52. The apparatus of claim 47, wherein the at least one memory and the computer program code are configured, with the at least one processor, to cause the apparatus to utilize the channel reservation procedure as a preliminary channel reservation procedure preceding a transmission on at least one reserved channel, wherein the preliminary channel reservation limits channel reservation options of other communication apparatuses.

53. The apparatus of claim 47, wherein the at least one memory and the computer program code are configured, with the at least one processor, to cause the apparatus to specify, in the reservation request message, a start time, a duration, and a periodicity of the reservations for said at least one secondary channel being reserved.

54. The apparatus of claim 47, wherein the at least one memory and the computer program code are configured, with the at least one processor, to cause the apparatus to:
specify, in the reservation request message a plurality of secondary channels being reserved;
specify, in the reservation request message, a first communication direction to a first subset of the plurality of secondary channels being reserved; and
specify, in the reservation request message, a second communication direction different from the first communication direction to a second subset of the plurality of secondary channels being reserved.

55. The apparatus of claim 47, wherein the at least one memory and the computer program code are configured, with the at least one processor, to cause the apparatus to support in the wireless communication a channel set comprising a primary channel and at least one secondary channel, cause the wireless communication apparatus to transmit the reservation request message on a secondary channel and, upon the completed reservation procedure, cause the wireless communication apparatus to carry out a channel contention procedure on the secondary channel before utilizing the reserved at least one secondary channel in the wireless communication.

56. An apparatus comprising:
at least one processor; and
at least one memory including a computer program code, wherein the at least one memory and the computer program code are configured, with the at least one processor, to cause the apparatus to:
acquire a reservation request message comprising information elements specifying at least one secondary channel being reserved and a communication direction for at least one channel being reserved;
check for any conflicting reservations in said at least one secondary channel being reserved;
cause a wireless communication apparatus to transmit a reservation response message indicating a conflicting reservation, if said conflicting reservation has been detected;
upon completed reservation procedure, cause the communication apparatus to utilize the reserved at least one secondary channel, wherein no conflict was detected, in wireless communication in the communication direction specified in the reservation request message.
